(19) United States
(12) Patent Application Publication
(10) Pub. No.: US 2026/0332035 A1
(43) Pub. Date: Oct. 22, 2026

(54) WINDING COMPONENT AND POWER SUPPLY DEVICE

(71) Applicant: TDK Corporation, Tokyo (JP)

(72) Inventors: Daiki HIRAOKA, Tokyo (JP); Akira HIRAOKA, Tokyo (JP); Takuya SAKAMOTO, Tokyo (JP); Komei TAKAGI, Tokyo (JP); Masahiro GAMOU, Tokyo (JP)

(73) Assignee: TDK Corporation, Tokyo (JP)

(21) Appl. No.: 19/529,499

(22) Filed: Feb. 4, 2026

(30) Foreign Application Priority Data
Feb. 6, 2025 (JP) 2025-018218

(51) Int. Cl. H02M 1/14; H01F 27/24; H01F 27/29

(52) U.S. Cl. CPC H02M 1/143; H01F 27/24; H01F 27/292

(57) ABSTRACT

The present disclosure provides a winding component and a power supply device capable of suppressing generation of noise or the like, with a relatively simple configuration. The winding component according to the present disclosure includes: a first core; a second core disposed facing the first core; a first output bus bar via which a first voltage is output; and a second output bus bar via which a second voltage is output, in which the first output bus bar and the second output bus bar are disposed between the first core and the second core, and a direction of a first current passed through the first output bus bar is different from a direction of a second current passed through the second output bus bar.

### CROSS-REFERENCE TO RELATED APPLICATIONS

The present application claims priority under 35 U.S.C. § 119 to Japanese Patent Application No. 2025-018218 filed on Feb. 6, 2025, the entire contents of which are incorporated herein by reference.

### FIELD

The present disclosure relates to a winding component and a power supply device.

### BACKGROUND

In relation to multi-output DC power supply devices, there have been some disclosures. For example, Patent Publication JP-A-5-015152 discloses a multi-output DC power supply device including a first secondary-side circuit for obtaining a first output voltage and a second secondary-side circuit for obtaining a second output voltage. The multi-output DC power supply device disclosed in Patent Publication JP-A-5-015152 achieves space saving by using a common core for the choke coils for the first output and the second output. The power supply device described in Patent Publication JP-A-5-015152 enables a reduction of ripple current in the first output voltage, by using, as the number of turns of the first choke coil and second choke coil, a number proportional to the turn ratio of the transformer.

### SUMMARY

However, in the multi-output DC power supply device described in Patent Publication JP-A-5-015152, there is room for further improvement, because noise may be generated between the plurality of output circuits, for example.

One aspect of the present disclosure has been made in view of such circumstances, and an object of the present disclosure is to provide a winding component and a power supply device capable of suppressing generation of noise or the like, with a relatively simple configuration.

A winding component according to one aspect of the present disclosure includes: a first core; a second core disposed facing the first core; a first output bus bar via which a first voltage is output; and a second output bus bar via which a second voltage is output, in which the first output bus bar and the second output bus bar are disposed between the first core and the second core, and a direction of a first current passed through the first output bus bar is different from a direction of a second current passed through the second output bus bar.

Furthermore, according to another aspect of the present disclosure, a power supply device includes a voltage input unit, a voltage conversion unit, a voltage output unit, and the winding component.

According to the present disclosure, it is possible to provide a winding component and a power supply device capable of suppressing generation of noise or the like, with a relatively simple configuration.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1A is a schematic top view of a power supply device according to an example embodiment;

FIG. 1B is a schematic perspective view of the power supply device according to the example embodiment;

FIG. 2A is a schematic top view of the interior of the power supply device according to the example embodiment;

FIG. 2B is a schematic perspective view of the interior of the power supply device according to the example embodiment;

FIG. 3A is a schematic perspective view of a winding component according to the example embodiment;

FIG. 3B is a schematic cross-sectional view of the winding component according to the example embodiment;

FIG. 4A is a schematic top view of a spacer according to the example embodiment;

FIG. 4B is a schematic perspective view of the spacer according to the example embodiment;

FIG. 5A is a schematic top view of the power supply device according to the example embodiment;

FIG. 5B is a schematic perspective view of the power supply device according to the example embodiment;

FIG. 6A is a schematic top view of the power supply device according to the example embodiment;

FIG. 6B is a schematic perspective view of the power supply device according to the example embodiment;

FIG. 7 is a schematic cross-sectional view of the winding component according to the example embodiment;

FIG. 8A is a schematic cross-sectional view of the winding component according to the example embodiment;

FIG. 8B is a schematic cross-sectional view of the winding component according to the example embodiment;

FIG. 8C is a schematic cross-sectional view of the winding component according to the example embodiment;

FIG. 8D is a schematic cross-sectional view of the winding component according to the example embodiment;

FIG. 9A shows results of a self-inductance analysis of the winding component according to the example embodiment;

FIG. 9B shows results of a coupling coefficient analysis of the winding component according to the example embodiment;

FIG. 10A is a schematic cross-sectional view of the winding component according to the example embodiment;

FIG. 10B is a schematic cross-sectional view of the winding component according to the example embodiment;

FIG. 11A is a schematic top view of the spacer according to the example embodiment;

FIG. 11B is a schematic side view of the spacer according to the example embodiment;

FIG. 11C is a schematic perspective view of the spacer according to the example embodiment;

FIG. 11D is a schematic perspective view of the spacer according to the example embodiment;

FIG. 11E is a schematic side view of the winding component according to the example embodiment;

FIG. 12A is a schematic perspective view of the winding component according to the example embodiment;

FIG. 12B is a schematic cross-sectional view of the winding component according to the example embodiment;

FIG. 13A is a schematic cross-sectional view of the winding component according to the example embodiment;

FIG. 13B is a schematic cross-sectional view of the winding component according to the example embodiment; and

FIG. 13C is a schematic cross-sectional view of the winding component according to the example embodiment.

### DETAILED DESCRIPTION

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

One example embodiment of the present disclosure (hereinafter, also referred to as “the example embodiment”) will now be explained with reference to the accompanying drawings. It should be noted that, in the drawings appended herein, the scales, the ratio of vertical and horizontal sizes, and the like may be different from those of the actual product or exaggerated for the illustrative purposes and the sake of the ease of understanding.

An X-axis, a Y-axis, and a Z-axis may be shown in each of the drawings. The X-axis, Y-axis and Z-axis together form a right-handed three-dimensional orthogonal coordinate system. Hereinafter, the direction to which the arrow of the X-axis is pointing may be referred to as +X direction, and the opposite direction of the arrow may be referred to as −X direction. The same applies to the other axes. Note that the +Z direction and the −Z direction may be referred to as “upper side” or “upper direction” and “lower side” or “lower direction”, respectively. Furthermore, the Z-axis direction may be referred to as a “stacking direction”. Furthermore, planes orthogonal to the X-axis, the Y-axis, or the Z-axis may be referred to as a YZ plane, a ZX plane, or an XY plane. However, these directions and the like are used for the convenience of explaining relative positional relationships. Accordingly, these directions and the like are not intended to define the absolute positional relationships.

Also, hereinafter, terms and/or numerical values representing a shape and/or a geometric condition are not limiting in a strict sense, and may be construed as including ranges where similar functions may be achieved. Examples of such terms include “parallel” and/or “orthogonal”. Examples of such numerical values include “length value” and/or “angle value”.

Also, when there is a description that one element is disposed “on”, “under”, “on the upper side of”, “on the lower side of”, “in the upper direction of”, or “in a lower direction of” another element, possible configurations include a configuration where the one element is in direct contact with the other element, as well as a configuration in which there is another element between the one element and the other element. The configuration in which there is another element between the one element and the other element may be described, using other words, as the one element being in indirect contact with the other element.

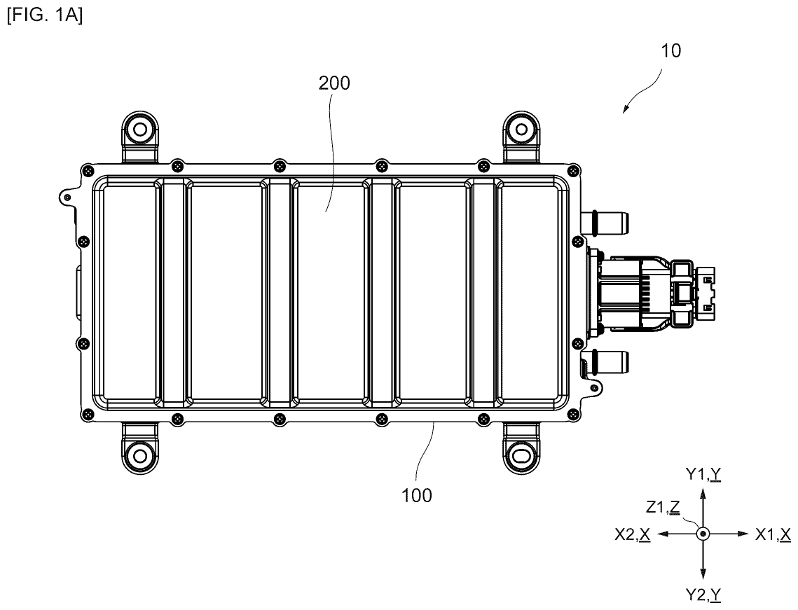

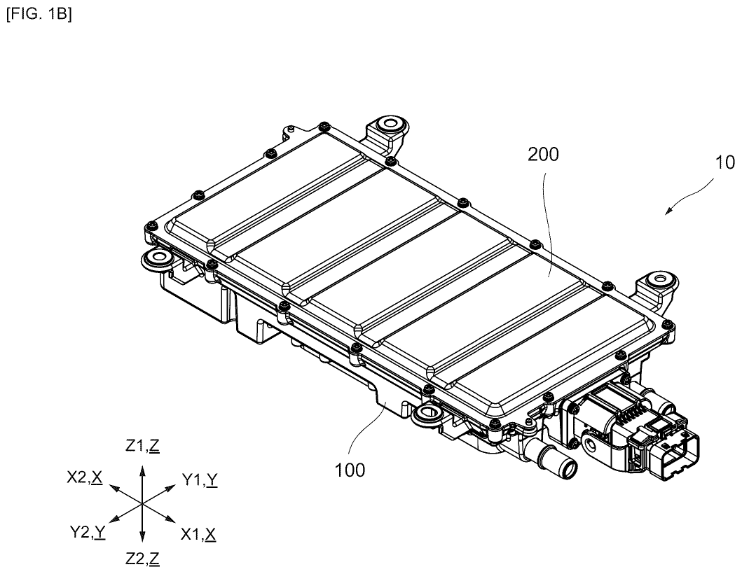

Furthermore, for the purpose of explaining the relative directional relationships, the right direction on the paper surface of FIG. 1A, to be described later, will be referred to as a right direction X1, and the left direction being the opposite direction of the right direction on the paper surface will be referred to as a left direction X2. Both of these directions may be collectively referred to as a left-right direction X. Further, the upper direction on the paper surface of FIG. 1A will be referred to as a front direction Y1, and the lower direction that is the opposite direction of the upper direction on the paper surface will be referred to as a rear direction Y2. Both of these directions may be collectively referred to as a front-back direction Y. Further, a front-back direction perpendicular to the paper surface of FIG. 1A will be referred to as a lower direction Z2, and the front direction perpendicular to the paper surface toward the opposite direction of the lower direction will be referred to as an upper direction Z1. Both of these directions may be collectively referred to as an up-down direction Z. A top view (bottom view) refers to a viewpoint looking at a power supply device 10 or the like from the upper direction Z1 (lower direction Z2) toward the lower direction Z2 (upper direction Z1).

Moreover, in the following description, redundant description may be omitted by assigning the identical or similar reference signs to the identical portions and/or portions having similar functions. The ratios of the sizes in the drawings may differ from the actual ratios. Configuration according to the example embodiment may be partly omitted in the drawings.

FIG. 1A is a schematic top view illustrating the external appearance of the power supply device 10 according to the example embodiment, and FIG. 1B is a schematic perspective view illustrating the external appearance of the power supply device 10 according to the example embodiment. As illustrated in FIGS. 1A and 1B, the power supply device 10 according to the example embodiment includes a base plate 100 one side (upper side) of which is open, and a cover 200 positioned in the upper direction Z1 of the base plate 100.

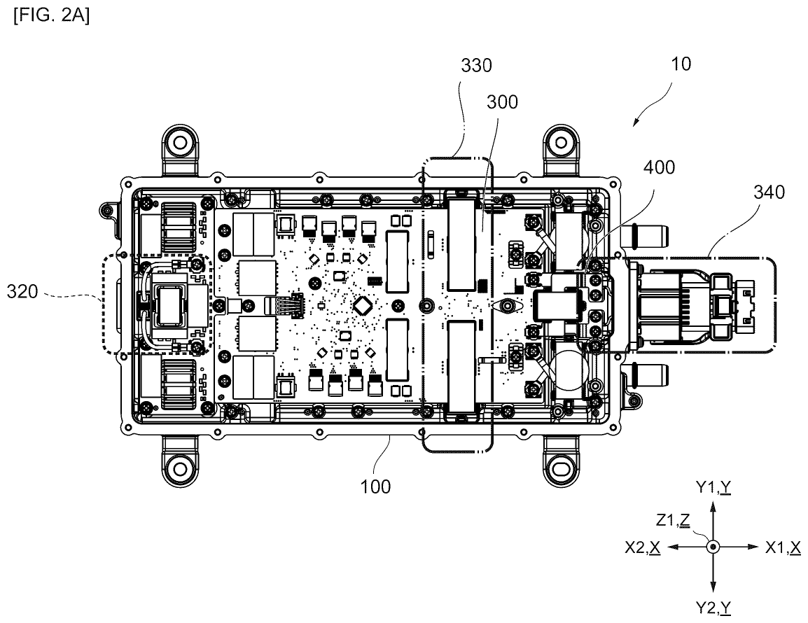

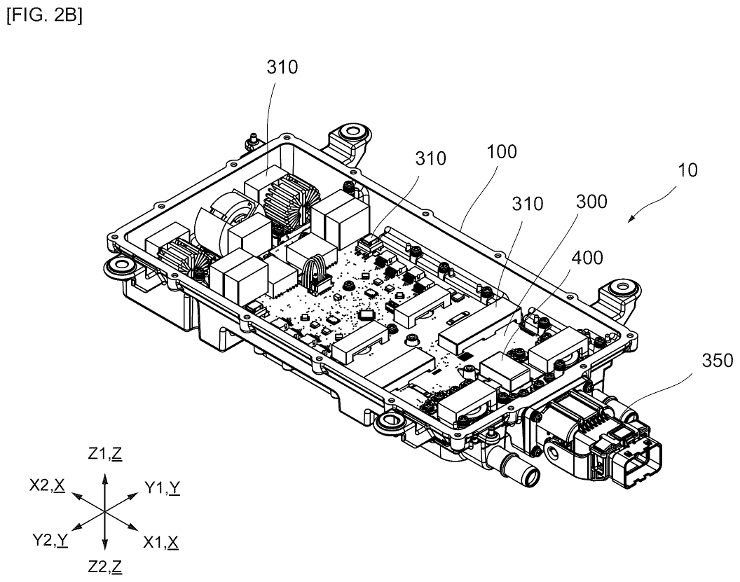

FIG. 2A is a top view of the interior of the power supply device 10 with the cover 200 of the example embodiment removed, and FIG. 2B is a perspective view of the interior of the power supply device 10. As illustrated in FIGS. 2A and 2B, an electronic board 300 is housed inside of the base plate 100.

As illustrated in FIGS. 2A and 2B, a winding component 400 according to the example embodiment is disposed on the electronic board 300. The winding component 400 is positioned, for example, in the right direction X1 of the electronic board 300 in FIGS. 2A and 2B. In the power supply device 10 according to the example embodiment, a plurality of other electronic components 310 may be disposed on the electronic board 300, in addition to the winding component 400. These electronic components 310 may include a voltage input unit 320, a voltage conversion unit 330 (transformer unit 330), and a voltage output unit 340 illustrated in FIG. 2A.

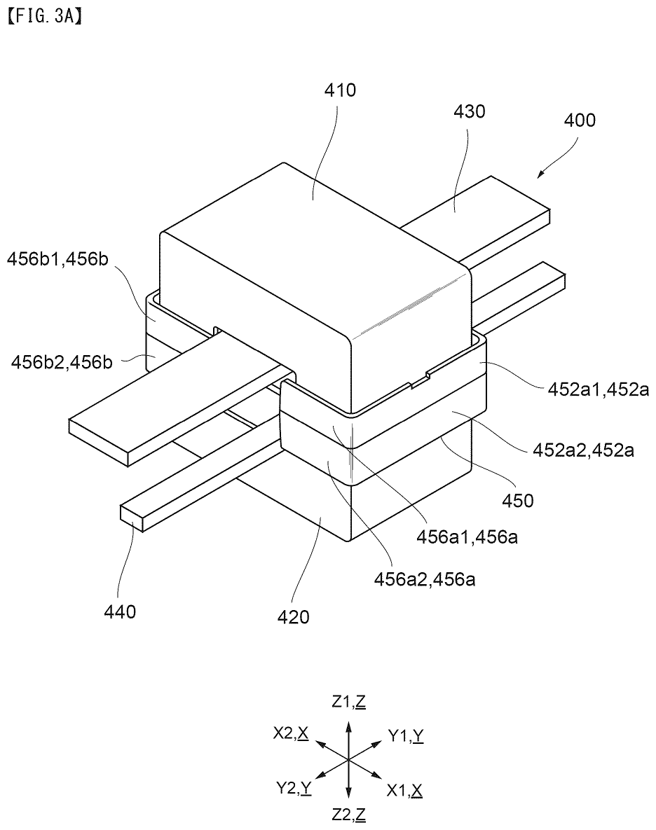

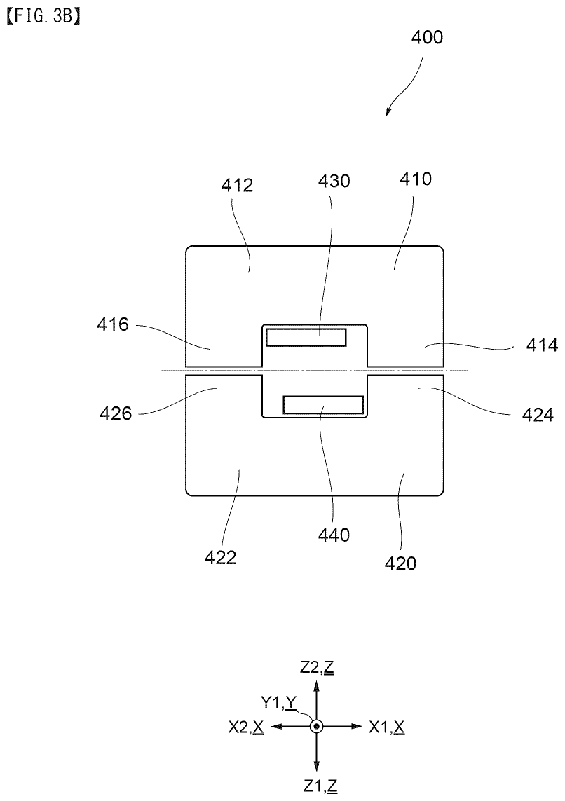

FIG. 3A is a schematic perspective view illustrating an enlargement of the winding component 400 according to the example embodiment. FIG. 3B is a schematic cross-sectional view of the winding component 400 according to the example embodiment. FIG. 3B is a sectional view of the winding component 400, with a spacer 450 (to be described later) removed, from a viewpoint in a direction perpendicular to the ZX plane.

The winding component 400 according to the example embodiment includes: a first core 410; a second core 420 disposed facing the first core 410; a first output bus bar 430 via which a first voltage is output; a second output bus bar 440 via which a second voltage is output, and the first output bus bar 430 and the second output bus bar 440 are disposed between the first core 410 and the second core 420, the direction of a first current passed through the first output bus bar 430 (e.g., the front direction Y1) is different from the direction of a second current passed through the second output bus bar 440 (e.g., the rear direction Y2).

In the winding component 400 according to the example embodiment, with the configuration described above, because common cores (the first core 410 and the second core 420) are used for the plurality of output bus bars (the first output bus bar 430 and the second output bus bar 440), it is possible to achieve space saving of the winding component 400, for example. Also, because the winding component 400 according to the example embodiment is configured in such a manner that the plurality of output bus bars (the first output bus bar 430 and the second output bus bar 440) have different polarities, it is possible to suppress noise between the output bus bars, for example. Furthermore, it is also possible to suppress magnetic saturation, for example.

As illustrated in FIG. 3B, the first core 410 includes a body 412, and a first leg 414 and a second leg 416 that extend in the lower direction Z2, on the sides in the right direction X1 and the left direction X2 of the body 412, respectively, in a cross-sectional view (in a view of the winding component 400 from a direction perpendicular to the ZX plane). Similarly to the first core 410, the second core 420 includes a body 422, and a first leg 424 and a second leg 426 that extend in the upper direction Z1, on the sides in the right direction X1 and the left direction X2 of the body 422, respectively, in a cross-sectional view (in a view of the winding component 400 from a direction perpendicular to the ZX plane).

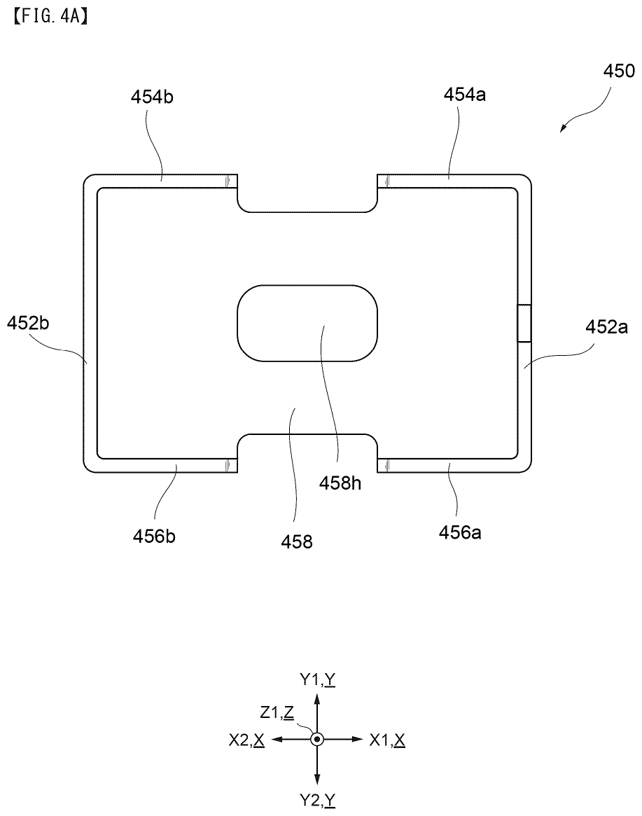

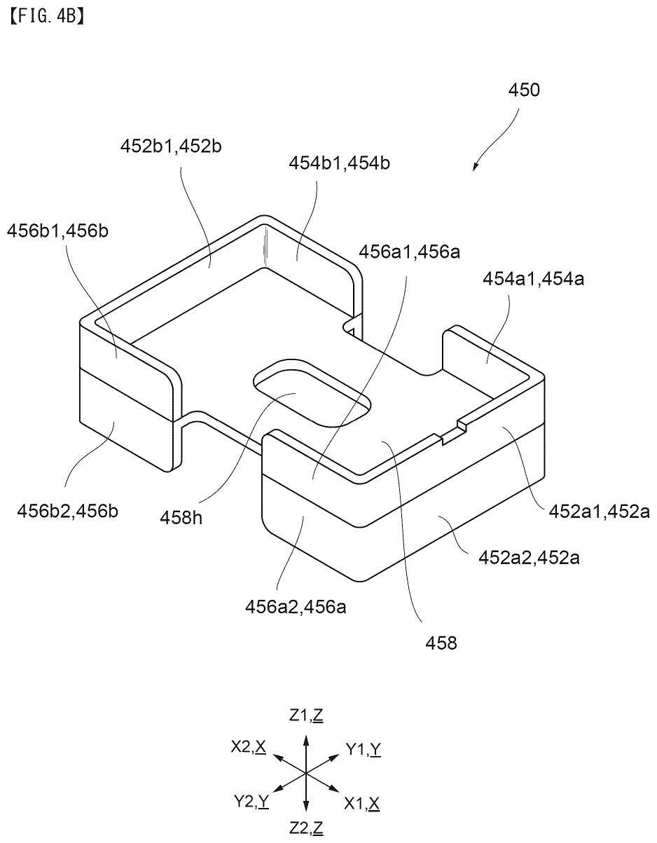

FIG. 4A is a top view of the spacer 450 disposed between the first core 410 and the second core 420 in the winding component 400. FIG. 4B is a perspective view of the spacer 450.

As illustrated in FIG. 4A, the spacer 450 includes a right wall 452a, a first front wall 454a, a first rear wall 456a, and a left wall 452b, a second front wall 454b, a second rear wall 456b, and a spacer body 458. As illustrated in FIG. 4B, the right wall 452a includes a portion 452a1 positioned in the upper direction Z1 of the spacer body 458, and a portion 452a2 positioned in the lower direction Z2. Similarly, the first front wall 454a includes a portion 454a1 positioned in the upper direction Z1 of the spacer body 458 and a portion 454a2 (not illustrated in FIG. 4B) positioned in the lower direction Z2. The first rear wall 456a includes a portion 456a1 in the upper direction Z1 and a portion 456a2 in the lower direction Z2. The left wall 452b includes a portion 452b1 positioned in the upper direction Z1 of the spacer body 458 and a portion 452b2 (not illustrated in FIG. 4B) positioned in the lower direction Z2. The second front wall 454b includes a portion 454b1 in the upper direction Z1 and a portion 454b2 (not illustrated in FIG. 4B) in the lower direction Z2. The second rear wall 456b includes a portion 456b1 in the upper direction Z1, and a portion 456b2 in the lower direction Z2. As illustrated in FIGS. 4A and 4B, the spacer body 458 may have a hole 458h.

As illustrated in FIGS. 3A and 4B, the first leg 414 of the first core 410 is housed in the space surrounded by the portion 452a1 of the right wall 452a, the portion 454a1 of the first front wall 454a, and the portion 456a1 of the first rear wall 456a, the portions 452a1, 454a1, and 456a1, all being positioned in the upper direction Z1 of the spacer body 458. Similarly, the second leg 416 of the first core 410 is housed in the space surrounded by the portion 452b1 of the left wall 452b, the portion 454b1 of the second front wall 454b, and the portion 456b1 of the second rear wall 456b, the portions 452b1, 454b1, and 456b1 all being in the upper direction Z1 of the spacer body 458.

The first leg 424 of the second core 420 is housed in the space surrounded by the portion 452a2 of the right wall 452a, the portion 454a2 (not illustrated) of the first front wall 454a, and the portion 456a2 of the first rear wall 456a, the portions 452a2, 454a2, and 456a2 all being in the lower direction Z2 of the spacer body 458. The second leg 426 of the second core 420 is housed in a space surrounded by the portion 452b2 (not illustrated) of the left wall 452b, the portion 454b2 (not illustrated) of the second front wall 454b, and the portion 456b2 of the second rear wall 456b, the portions 452b2, 454b2, and 456b2 all being in the lower direction Z2 of the spacer body 458.

In the winding component 400 according to the example embodiment, with the configuration described above, the first core 410 and the second core 420 are disposed in a manner separated from each other by the spacer 450 in the up-down direction Z.

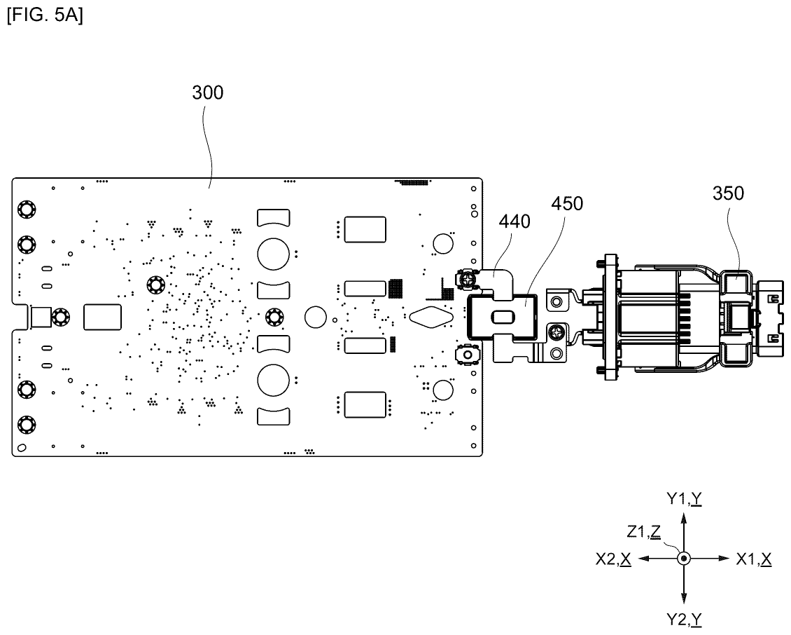

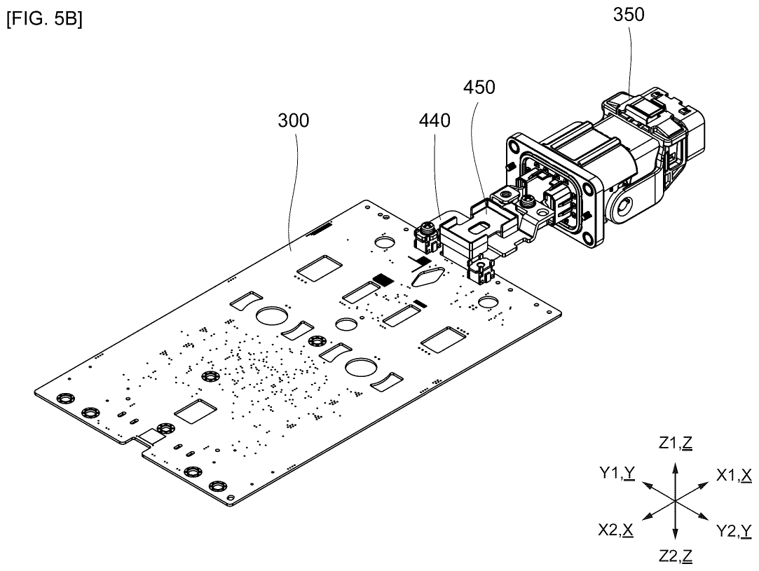

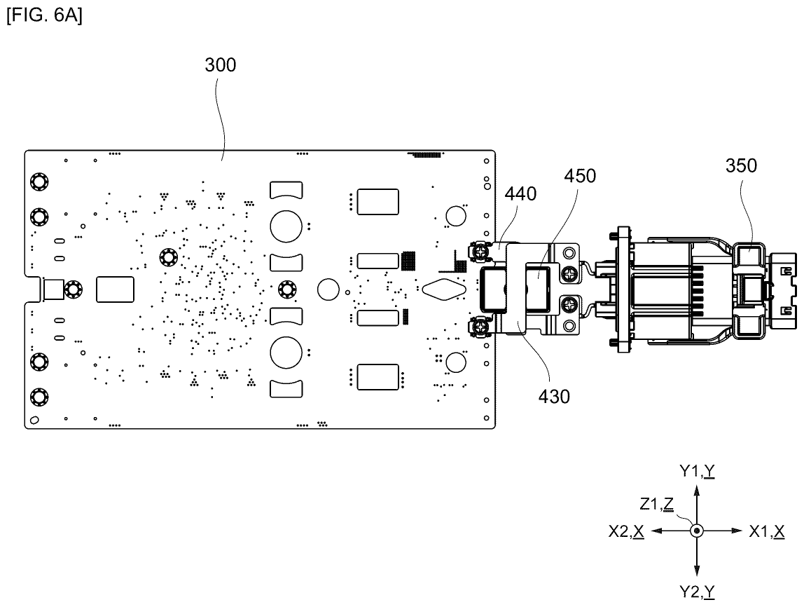

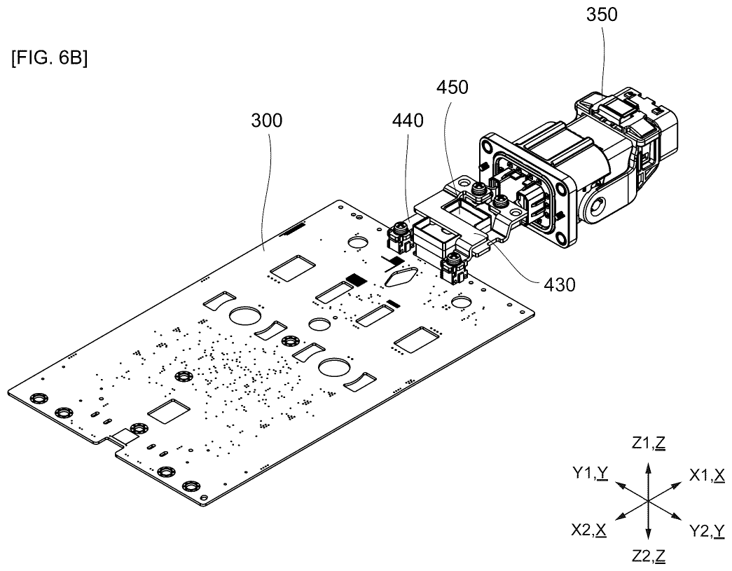

FIG. 5A is a top view illustrating a structure of the electronic board 300 and an output terminal 350 of the power supply device 10 according to the example embodiment, in a view from the upper direction Z1, with the first core 410 and the first output bus bars 430 of the winding component 400 removed (that is, with the base plate 100 and the cover 200 removed from the power supply device 10). FIG. 5B is a perspective view illustrating the electronic board 300 and the output terminal 350, with the first core 410 and the first output bus bar 430 of the winding component 400 removed. FIGS. 6A and 6B are a top view and a perspective view illustrating the electronic board 300 and the output terminal 350, with the first output bus bar 430 of the winding component 400 provided to the configuration illustrated in FIG. 5A.

As illustrated in FIGS. 5A and 5B, the second output bus bar 440 is provided in a manner passed between the first front wall 454a and the second front wall 454b of the spacer 450, and between the first rear wall 456a and the second rear wall 456b, in a direction from the front direction Y1 toward the rear direction Y2, in a manner electrically connecting the electronic board 300 and the output terminal 350. Also, as illustrated in FIGS. 6A and 6B, the first output bus bar 430 is passed between the first front wall 454a and the second front wall 454b of the spacer 450, and between the first rear wall 456a and the second rear wall 456b, in a direction from the rear direction Y2 toward the front direction Y1, in a manner connecting the electronic board 300 and the output terminal 350. Accordingly, in the winding component 400 according to the example embodiment, the first output bus bar 430 is configured to pass a current in the direction from the rear direction Y2 toward the front direction Y1 (the first current in the example embodiment), and the second output bus bar 440 is configured to pass a current from the front direction Y1 to the rear direction Y2 (the second current in the example embodiment). In the winding component 400 according to the example embodiment, with this configuration, for example, it is possible to suppress noise that may be generated by the first output bus bar 430 and the second output bus bar 440, as described above.

Also, in the winding component 400 according to the example embodiment, for example, as illustrated in FIGS. 5A to 6B, the start point and the end point of the winding of the first output bus bar 430 are not close to the start point and the end point of the winding of the second output bus bar 440, respectively. With this configuration, in the winding component 400 according to the example embodiment, it is possible to reduce high frequency noise propagating along stray capacitance in each of the first output bus bar 430 and the second output bus bar 440, for example.

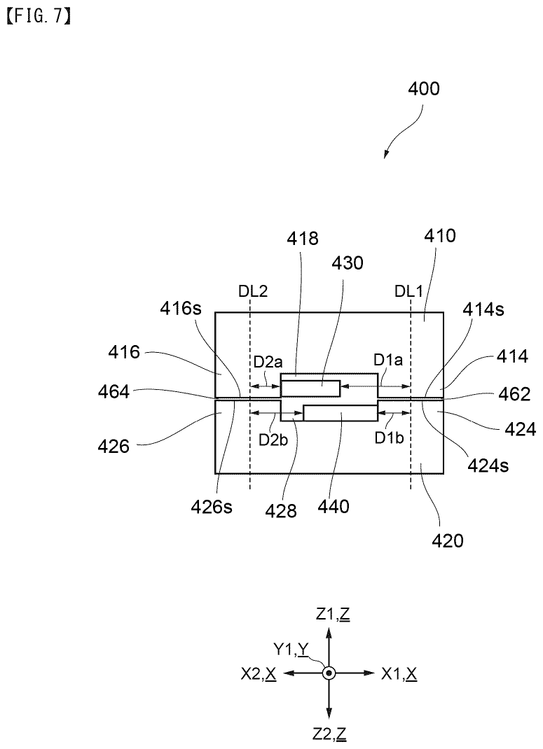

FIG. 7 illustrates a schematic cross-sectional view (a cross-sectional view as viewed from the rear direction Y2) of the winding component 400 according to the example embodiment. In the example embodiment, for example, as illustrated in FIG. 7, the first core 410 may include a first core facing surface 414s, a second core facing surface 416s, and a first recess 418 provided between the first core facing surface 414s and the second core facing surface 416s. The second core 420 may include a third core facing surface 424s, a fourth core facing surface 426s, and a second recess 428 provided between the third core facing surface 424s and the fourth core facing surface 426s. Also, for example, the first core 410 and the second core 420 may have the first core facing surface 414s and the third core facing surface 424s facing each other across a first gap 462, in a first direction (up-down direction Z) intersecting with the direction of the first current (−Y direction) and the direction of the second current (+Y direction), and have the second core facing surface 416s and the fourth core facing surface 426s facing each other across a second gap 464, in the first direction (up-down direction Z). Also, for example, the first recess 418 and the second recess 428 may be disposed in a manner facing each other in the first direction (up-down direction Z), and the first output bus bar 430 may be disposed inside of the first recess 418. Also, for example, the second output bus bar 440 may be disposed inside of the second recess 428, and the distance between the first gap 462 and the first output bus bar 430 (a distance D1a) may be different from the distance between the first gap 462 and the second output bus bar 440 (a distance D1b).

In the example embodiment, the distance D1a between the first gap 462 and the first output bus bar 430 described above may be the distance between a straight line (indicated by the broken line DL1 in FIG. 7) passing through the center of the first gap 462 in the left-right direction X, in parallel with the up-down direction Z, and the first output bus bar 430 (the end surface of the first output bus bar 430 in the right direction X1), in the cross-sectional view of the winding component 400 illustrated in FIG. 7 (in a view of the winding component 400 from a direction perpendicular to the ZX plane), for example. Similarly, the distance D1b between the first gap 462 and the second output bus bar 440 may be a distance D1b between a straight line, as indicated as the broken line DL1 in FIG. 7, passing through the center of the first gap 462 in the left-right direction X, in parallel with the up-down direction Z, and the second output bus bar 440 (the end surface of the second output bus bar 440 in the right direction X1), for example.

In the winding component 400 according to the example embodiment, by positioning the first core 410, the second core 420, the first output bus bar 430, and the second output bus bar 440, in the manner described above, adjustments of the coupling coefficient and the self-inductances of the first output bus bar 430 and the second output bus bar 440 are made possible. Accordingly, for example, it is possible to improve the noise cut-off characteristics of the winding component 400, e.g., suppressing the propagation of the noise to another output and an increase in the impedance.

Also, in the example embodiment, for example, the distance between the second gap 464 and the first output bus bar 430 (a distance D2a) may be different from the distance between the second gap 464 and the second output bus bar 440 (a distance D2b). In the example embodiment, for example, the distance D2a between the second gap 464 and the first output bus bar 430 may be a distance between the straight line (indicated by the broken line DL2 in FIG. 7) passing through the center of the second gap 464 in the left-right direction X, in parallel with the up-down direction Z, and the first output bus bar 430 (the end surface of the first output bus bar 430 in the left direction X2), in the cross-sectional view of the winding component 400 illustrated in FIG. 7 (in a view of the winding component 400 from a direction perpendicular to the ZX plane). Also, the distance D2b between the second gap 464 and the second output bus bar 440 may be a distance D2b between the straight line, as indicated by the broken line DL2 in FIG. 7, passing through the center of the second gap 464 in the left-right direction X, in parallel with the up-down direction Z, and the second output bus bar 440 (the end surface of the second output bus bar 440 in the left direction X2), for example. In the winding component 400 according to the example embodiment, because the coupling coefficient between and the self-inductances of the first output bus bar 430 and the second output bus bar 440 can also be adjusted in a manner similar to that described above, it is possible to improve the noise cut-off characteristics.

Also, in the winding component 400 according to the example embodiment, the cross-sectional area of the first output bus bar 430 in a direction orthogonal to the direction of the first current (+Y direction) may be different from the cross-sectional area of the second output bus bar 440 in the direction orthogonal to the direction of the second current (−Y direction). In the example embodiment, for example, as illustrated in FIG. 7, the cross-sectional area of the second output bus bar 440 may be larger than the cross-sectional area of the first output bus bar 430. It is also possible for the cross-sectional area of the first output bus bar 430 to be larger than the cross-sectional area of the second output bus bar 440. According to the example embodiment, such a configuration makes it possible to further reduce the propagation of noise to another output, for example. Therefore, it is possible to further improve the noise cut-off characteristics of the winding component 400.

Results of simulations of the coupling coefficients and the self-inductances in the winding component 400 according to the example embodiment will now be explained.

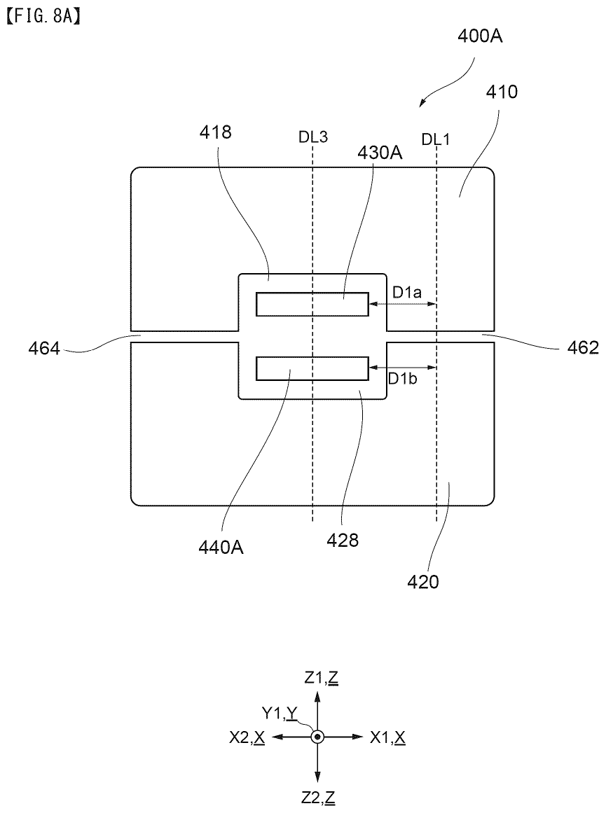

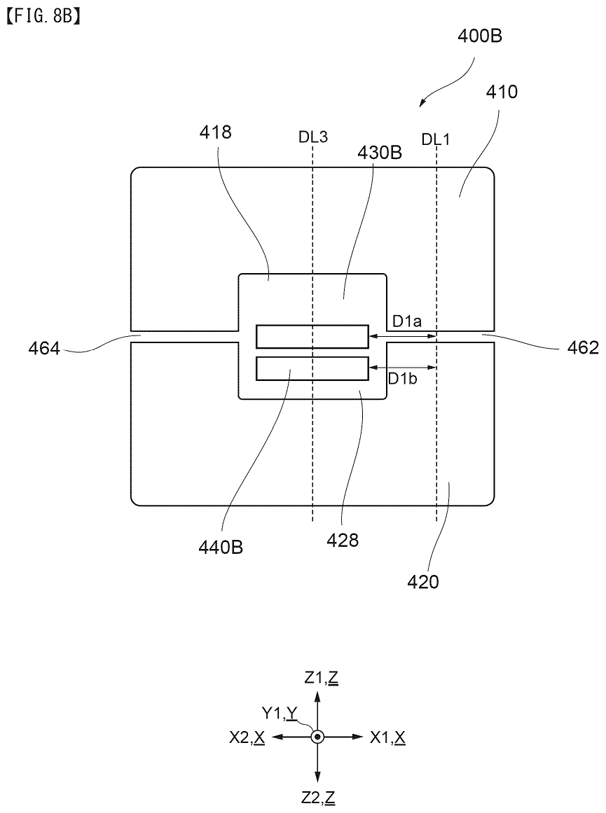

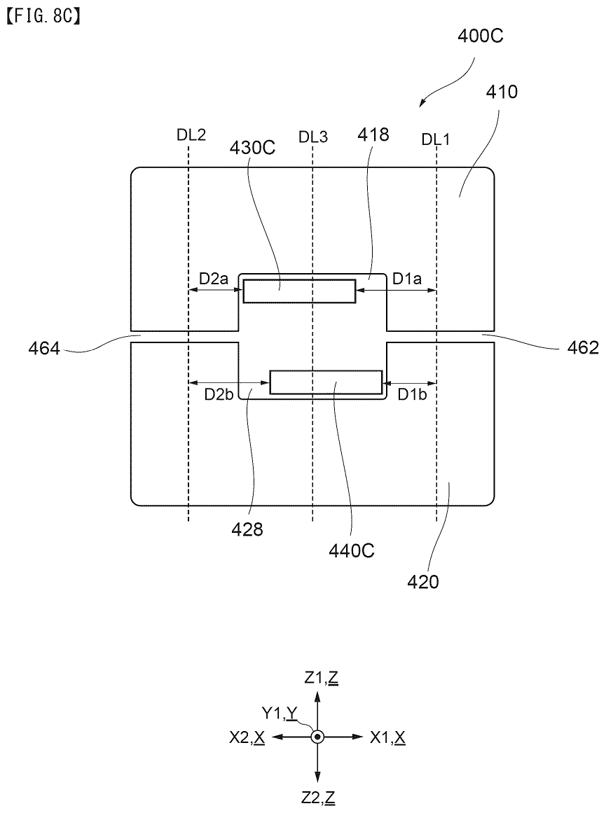

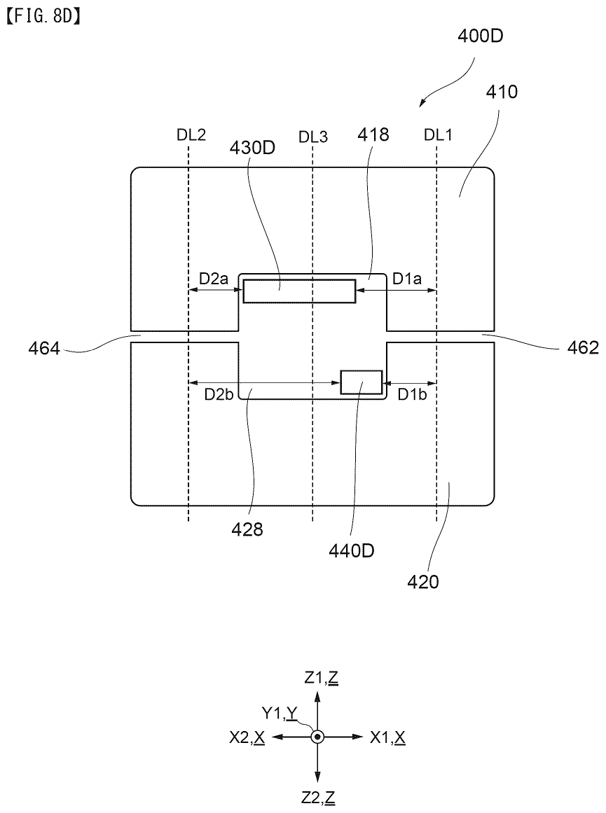

In the example embodiment, four types of winding components 400A, 400B, 400C, and 400D illustrated in FIGS. 8A to 8D, respectively, were used in the simulations. In the winding components 400A, 400B, 400C, and 400D, the first core 410 and the second core 420 have the same size, but the arrangements, the sizes, and/or the cross-sectional areas of the first output bus bar 430 and the second output bus bar 440 are different.

As illustrated in FIG. 8A, in a winding component 400A according to the example embodiment, a first output bus bar 430A and a second output bus bar 440A have the same shape in the cross-sectional view, and have substantially the same cross-sectional areas. Also, the first output bus bar 430A and the second output bus bar 440A are disposed at the same position in the left-right direction X. Specifically, the first output bus bar 430A and the second output bus bar 440A are disposed inside of the recess 418 of the first core 410 and the recess 428 of the second core 420, respectively, at positions where the distances thereof with respect to the first gap 462 (the first distance D1a and the second distance D1b) are substantially equal.

As illustrated in FIG. 8B, in the winding component 400B according to the example embodiment, a first output bus bar 430B and a second output bus bar 440B have the same shape in the cross-sectional view and substantially the same cross-sectional areas, and the first output bus bar 430B and the second output bus bar 440B are disposed at the same positions in the left-right direction X, but are different from the winding component 400A (FIG. 8A) in that the first output bus bar 430B is positioned further in the lower direction Z2 with respect to the second output bus bar 440B, and the second output bus bar 440B is positioned further in the upper direction Z1 with respect to the first output bus bar 430B. As illustrated in FIG. 8B, in the winding component 400B, the first output bus bar 430B is at a position substantially the same as the positions of the first gap 462 and the second gap 464 in the Z direction, and the second output bus bar 440B is at a position further in the upper direction Z1 inside of the second recess 428 of the second core 420.

As illustrated in FIG. 8C, in a winding component 400C according to the example embodiment, a first output bus bar 430C and a second output bus bar 440C have the same shape in the cross-sectional view, and have substantially the same cross-sectional areas; but the first output bus bar 430C and the second output bus bar 440C have different distances D1a and D1b with respect to the first gap 462 in the left-right direction X, respectively. As illustrated in FIG. 8C, in the winding component 400C, the first output bus bar 430C and the second output bus bar 440C are disposed in such a manner that the distance D1a is larger than the distance D1b. Also, as illustrated in FIG. 8C, in the winding component 400C, the first output bus bar 430C and the second output bus bar 440C are disposed in such a manner that the distance D2a and the distance D2b with respect to the second gap 464 are different from each other, and the first output bus bar 430C and the second output bus bar 440C are disposed in such a manner that the distance D2b between the second gap 464 and the second output bus bar 440C is larger than the distance D2a between the second gap 464 and the first output bus bar 430C.

As illustrated in FIG. 8D, in a winding component 400D according to the example embodiment, a first output bus bar 430D and a second output bus bar 440D have different shapes in the cross-sectional view and have different cross-sectional areas. As illustrated in FIG. 8D, the cross-sectional area of the first output bus bar 430D is larger than the cross-sectional area of the second output bus bar 440D. Also, the first output bus bar 430D and the second output bus bar 440D are positioned in such a manner that the distance D1a and the distance D1b thereof with respect to the first gap 462 are different from each other, and the distance D2a and the distance D2b thereof with respect to the second gap 464 are different from each other, in the left-right direction X. As illustrated in FIG. 8D, in the winding component 400D, the first output bus bar 430D and the second output bus bar 440D are disposed in such a manner that the distance D1a is larger than the distance D1b. Also, as illustrated in FIG. 8D, in the winding component 400D, in relation to the distance D2a and the distance D2b with respect to the second gap 464, the first output bus bar 430D and the second output bus bar 440D are disposed in such a manner that the distance D2b between the second gap 464 and the second output bus bar 440D is larger than the distance D2a between the second gap 464 and the first output bus bar 430D.

In the example embodiment, simulations were carried out to analyze the characteristics of the four winding components 400A, 400B, 400C, and 400D, having been respectively described above with reference to FIGS. 8A to 8D. In all of the winding components 400A, 400B, 400C, and 400D, UU 32.3x2 manufactured by TDK Corporation was used for each of the first core 410 and the second core 420, and the gaps (the first gaps 462 and the second gaps 464) between the first core 410 and the second core 420 in the up-down direction Z were both set to 1.0 mm. Also, in all of the winding components 400A, 400B, 400C, and 400D, the first output bus bar 430 had a width (a size in the left-right direction X) of 10.0 mm, a thickness (a size in the up-down direction Z) of 2.0 mm, and a length (a size in the front-back direction Y) of 70.5 mm. Also, in the winding components 400A, 400B, and 400C, the second output bus bar 440 (the second output bus bars 440A, 440B, and 440C) had a width of 10.0 mm, a thickness of 2.0 mm, and a length (a size in the front-back direction Y) of 70.5 mm. In the winding component 400D, the second output bus bar 440 (second output bus bar 440D) had a width of 3.6 mm, a thickness of 2.0 mm, and a length of 70.5 mm. In all of the winding components 400A, 400B, 400C, and 400D, a current of 140 A was passed through the first output bus bar 430 toward the front direction Y1 (+Y direction), and a current of 50 A was passed through the second output bus bar 440 toward the rear direction Y2 (−Y direction).

Using electromagnetic field analysis software (Maxwell 3D from Ansys, Inc), the self-inductances of the first output bus bars 430A, 430B, 430C, and 430D and the second output bus bars 440A, 440B, 440C, and 440D of the respective winding components 400A, 400B, 400C, and 400D were calculated. In addition, coupling coefficients between the first output bus bar 430A and the second output bus bar 440A, the first output bus bar 430B and the second output bus bar 440B, the first output bus bar 430C and the second output bus bar 440C, and the first output bus bar 430D and the second output bus bar 440D were also calculated. In the analysis, evaluations were carried out on the self-inductances and the coupling coefficients on the cross sections taken along a direction perpendicular to the ZX plane, near the center of the first core 410 and the second core 420 in the left-right direction X (shown by the dotted line DL3 in FIGS. 8A to 8D).

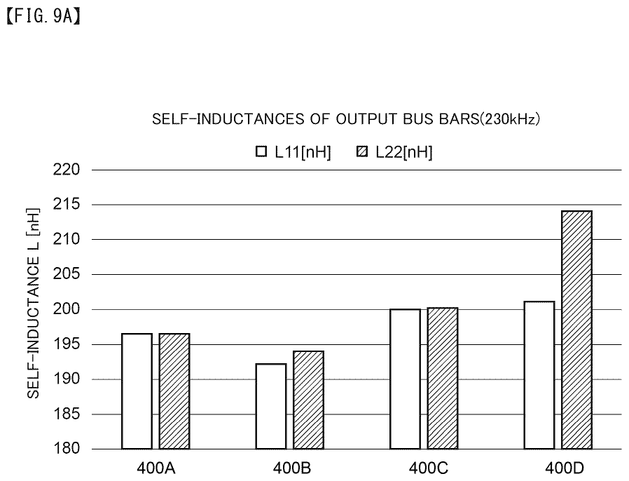

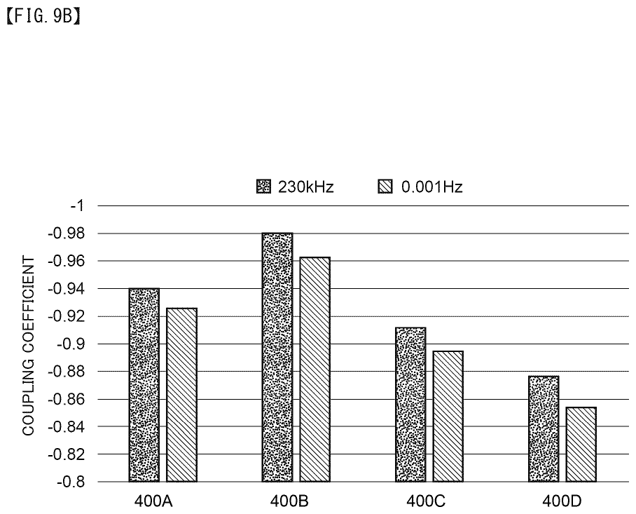

FIG. 9A shows the analysis results of the self-inductances of the first output bus bars 430A, 430B, 430C, and 430D, and the second output bus bars 440A, 440B, 440C and 440D (L11 (nH) and L22 (nH), respectively) in a case where the measurement frequency for the winding components 400A, 400B, 400C, and 400D was set to 230 kHz. FIG. 9B shows the analysis results of the coupling coefficients between the first output bus bar 430A and the second output bus bar 440A, the first output bus bar 430B and the second output bus bar 440B, the first output bus bar 430C and the second output bus bar 440C, and the first output bus bar 430D and the second output bus bar 440D, in a case where the measurement frequency was set to 230 kHz and 0.001 Hz.

As shown in the analysis results from the winding component 400D in FIG. 9A, for example, by providing the first output bus bar 430 and the second output bus bar 440 with different cross-sectional areas and/or shapes, the self-inductances thereof were successfully adjusted within the range of 201.1 (nH) and 214.1 (nH), respectively. Also, as shown in the analysis results from the winding components 400B, 400C, and 400D in FIGS. 9A and 9B, by positioning the first output bus bar 430 and the second output bus bar 440 asymmetrically (positioning not in a linear symmetry in the up-down direction Z with respect to the straight lines passing through the first gap 462 and the second gap 464 (straight lines in parallel with the left-right direction X in FIGS. 8A to 8D)), the self-inductances thereof were successfully adjusted within the range of approximately 192.3 (nH) and 201.1 (nH), and the coupling coefficients thereof were successfully adjusted within the range of approximately about −0.98 and −0.86.

As described above, in the winding component 400 according to the example embodiment, it was shown that, on the basis of the simulation results, the self-inductances of and the coupling coefficient between the first output bus bar 430 and the second output bus bar 440 can be adjusted by adjusting the arrangement, sizes, the cross-sectional areas, and/or the shapes of the output bus bars (the first output bus bar 430 and second output bus bar 440).

In the winding component 400, when the coupling coefficient between the first output bus bar 430 and the second output bus bar 440 is higher, greater energy is transferred between the first output bus bar 430 and the second output bus bar 440, and when the coupling coefficient is lower, less energy is transferred. When noises having opposite phases are generated in the first output bus bar 430 and the second output bus bar 440, respectively, for example, by adjusting the arrangement of the first output bus bar 430 and the second output bus bar 440 and setting the coupling coefficient relatively high, as shown in the analysis results (e.g., FIG. 9B) of the winding component 400B and 400C, the magnetic fluxes generated in the first output bus bar 430 and the second output bus bar 440 intensify each other to increase the impedance, so that the noise generated at the output terminal 350 can be reduced, effectively. Furthermore, when a noise is generated in either one of the first output bus bar 430 or the second output bus bar 440, for example, by providing the first output bus bar 430 and the second output bus bar 440 with different cross-sectional areas or shapes, as shown in the analysis results (e.g., FIG. 9B) of the winding component 400D, so as to make the coupling coefficient relatively low, the energy by which the noise is transferred to another output bus bar is reduced, so that the noise generated at the output terminal 350 can be reduced, effectively. In this manner, in the winding component 400 according to the example embodiment, by adjusting the coupling coefficient between the first output bus bar 430 and the second output bus bar 440 through the adjustment of the arrangement, the cross-sectional areas, the shapes, and the like of the first output bus bar 430 and the second output bus bar 440, for example, it is possible to take countermeasures against the noise that needs to be reduced.

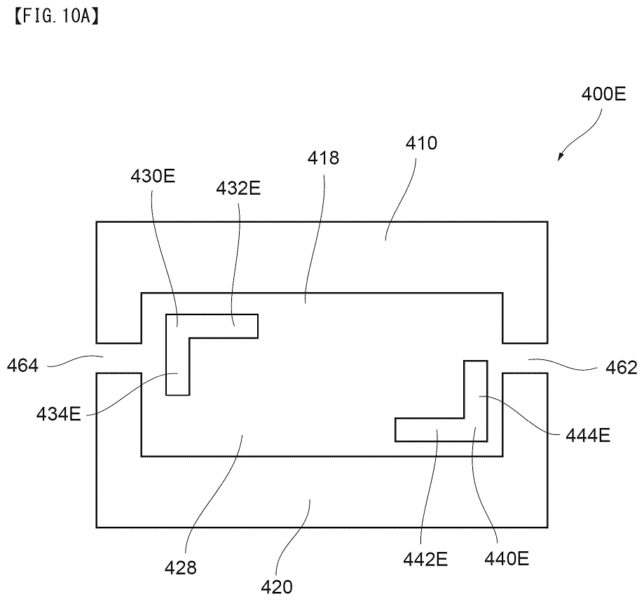

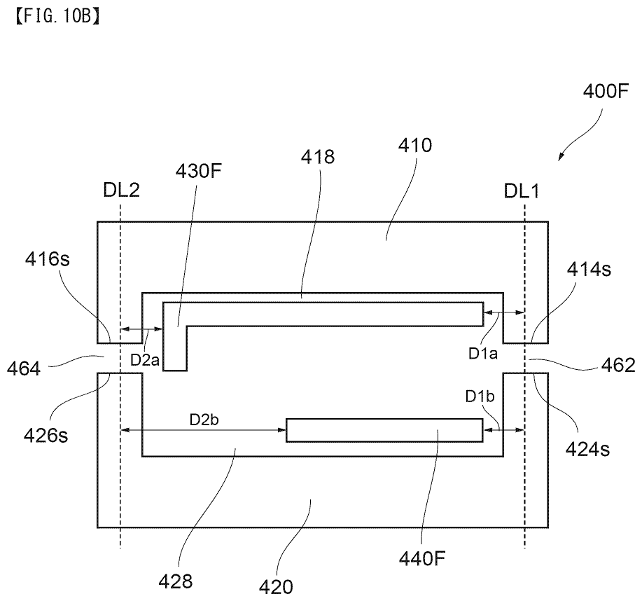

In the winding component 400 according to the example embodiment, the first output bus bar 430 and the second output bus bar 440 each have a rectangular parallelepiped shape, for example, but the example embodiment is not limited thereto. At least one of the first output bus bar 430 and the second output bus bar may include a bent portion, for example. FIG. 10A is a schematic cross-sectional view of such a winding component 400E. As illustrated in FIG. 10A, a first output bus bar 430E in the winding component 400E may include a first straight portion 432E that is in parallel with the left-right direction X, and a second straight portion 434E that is in parallel with the up-down direction Z. A second output bus bar 440E in the winding component 400E may also include a first straight portion 442E that is in parallel with the left-right direction X and a second straight portion 444E that is in parallel with the up-down direction Z. In this manner, in the winding component 400E, a bent portion is formed by the first straight portion 432E and the second straight portion 434E of the first output bus bar 430E, and a bent portion is formed by the first straight portion 442E and the second straight portion 444E of the second output bus bar 440E, for example.

In the winding component 400E according to the example embodiment, with the configuration described above, the distance between the first output bus bar 430E and the second output bus bar 440E can be set larger than that in the winding components described above (the winding components 400A (FIGS. 8A), 400B (FIGS. 8B), 400C (FIG. 8C), and 400D (FIG. 8D)). Accordingly, in the winding component 400E, propagation of noise between the plurality of output bus bars (the first output bus bar 430E and the second output bus bar 440E) can be reduced, for example. Accordingly, in the winding component 400E, the noise cut-off characteristics can be further improved.

In the example embodiment, when the configuration uses the first output bus bar 430 and the second output bus bar 440 with bent portions, as in the winding component 400E, the shapes and arrangement of the first output bus bar 430 and the second output bus bar 440 may also be adjusted. FIG. 10B is a schematic cross-sectional view of a winding component 400F in such a case. At this time, in the winding component 400F, the first core 410 includes a first core facing surface 414s, a second core facing surface 416s, and a first recess 418 provided between the first core facing surface 414s and the second core facing surface 416s; the second core 420 includes a third core facing surface 424s, a fourth core facing surface 426s, and a second recess 428 provided between the third core facing surface 424s and the fourth core facing surface 426s. The first core 410 and the second core 420 have the first core facing surface 414s and the third core facing surface 424s, respectively, that face each other across the first gap 462 in the first direction (up-down direction Z) intersecting with the direction of the first current (Y1 direction) and the direction of the second current (Y2 direction), the second core facing surface 416s and the fourth core facing surface 426s, respectively, that face each other across the second gap 464 in the first direction (up-down direction Z), and the first recess 418 and the second recess 428, respectively, that face each other in the first direction (up-down direction Z). Also, in the winding component 400F, the first output bus bar 430F is disposed inside of the first recess 418, and the second output bus bar 440F is disposed inside of the second recess 428. Further, the distance between the first gap 462 and the first output bus bar 430F (distance D1a) is substantially the same as the distance between the first gap 462 and the second output bus bar 440F (distance D1b), while the distance between the second gap 464 and the first output bus bar 430F (the distance D2a) is different from the distance between the second gap 464 and the second output bus bar 440F (distance D2b).

In the winding component 400F, with this configuration, the current loss can be reduced more, compared with the winding component 400E, for example. Further, the propagation of noise to another output can be reduced in a manner similar to the winding component 400E, because a relatively large distance can be ensured between the first output bus bar 430F and the second output bus bar 440F.

As described above with reference to FIGS. 10A and 10B, in the winding component 400E described with reference to FIG. 10A, both of the first output bus bar 430 and the second output bus bar 440 are provided with bent portions, but the configuration is not limited thereto. Even with a configuration in which the bent portion is provided to only one of the first output bus bar 430 and the second output bus bar 440, for example, as the winding component 400F described with reference to FIG. 10B, a relatively large distance can be ensured between the first output bus bar 430F and the second output bus bar 440F. Therefore, propagation of noise between the output bus bars can be suppressed effectively. In the manner described above with reference to FIGS. 10A and 10B, by adjusting the coupling coefficient between and the self-inductances of the first output bus bar 430 and the second output bus bar 440 using the shapes of the first output bus bar 430 and the second output bus bar 440, the propagation of noise can be suppressed further, for example.

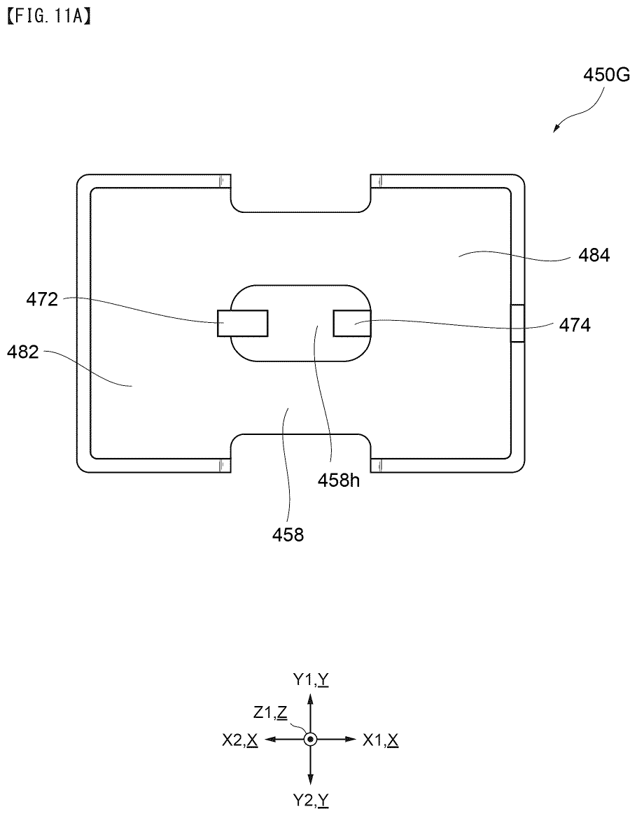

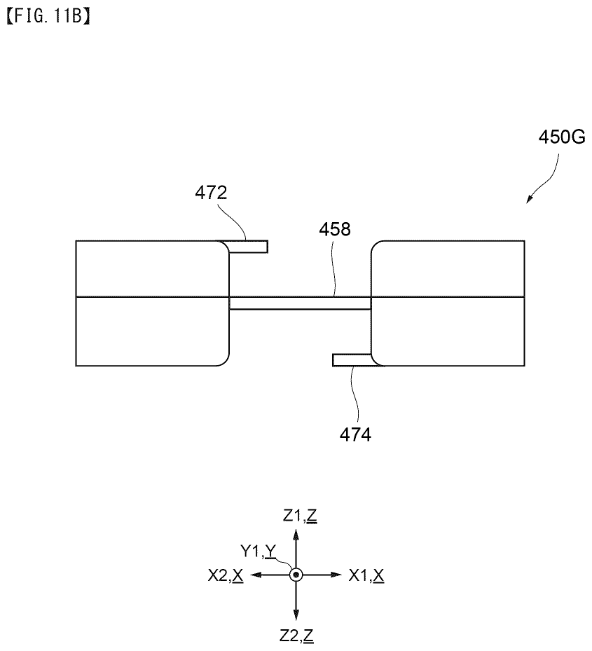

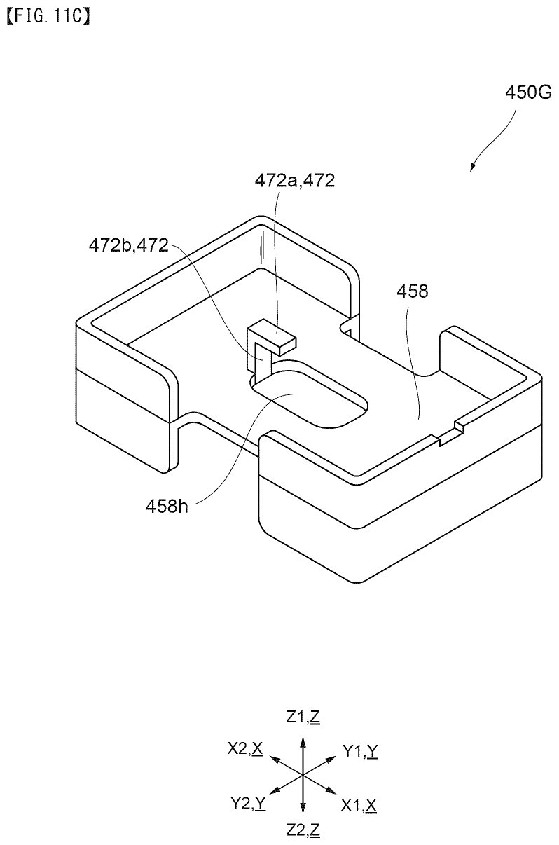

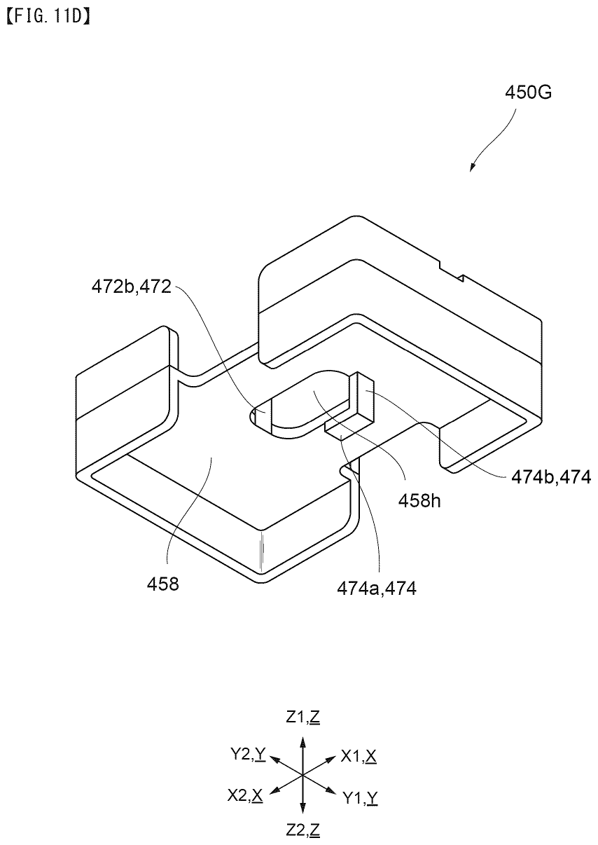

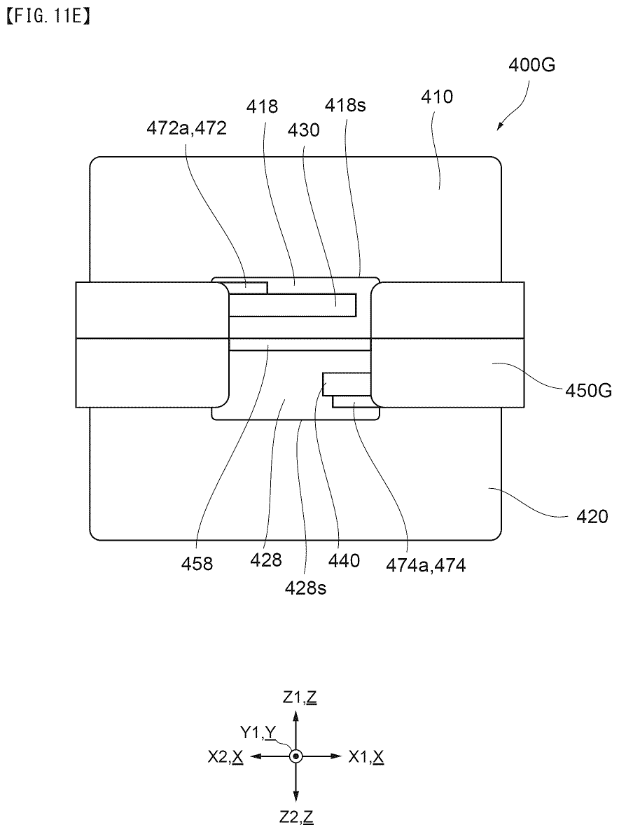

Another exemplary spacer 450G will now be explained with reference to FIGS. 11A to 11E. FIG. 11A is a plan view of the spacer 450G as viewed from the upper direction Z1; FIG. 11B is a side view as viewed from the right direction X1. FIG. 11C is a perspective view as viewed from the upper direction Z1; and FIG. 11D is a perspective view as viewed from the lower direction Z2. FIG. 11E is a side view of a winding component 400G including the first core 410, the second core 420, and the first output bus bar 430, and the second output bus bar 440 disposed inside of the spacer 450G, as viewed from the right direction X1.

In the winding component 400G according to the example embodiment, the spacer 450G may be provided with a plurality of claws (a first claw 472 and a second claw 474), for example. In other words, the winding component 400G further includes a spacer 450G (a spacer member in the example embodiment), and the spacer 450G (the spacer member in the example embodiment) includes a first spacer portion 482 that is to be disposed in the second gap 464, and a second spacer portion 484 that is to be disposed in the first gap 462, as illustrated in FIGS. 11A to 11D. As illustrated in FIG. 11A and the like, in the example embodiment, the first spacer portion 482 is a portion of the spacer 450G in the left direction X2 and the second spacer portion 484 is a portion of the spacer 450G in the right direction X1.

The first claw 472 is provided to the first spacer portion 482. The first claw 472 includes a third spacer portion 472a that is to be disposed between the first output bus bar 430 in the first recess 418 of the first core 410, and the bottom surface 418s of the first recess 418. As illustrated in FIG. 11C, the third spacer portion 472a of the first claw 472 is supported by a first support 472b provided in the upper direction Z1 from the end of the hole 458h of the spacer body 458 (the end in the left direction X2), and is provided in a manner extending toward the right direction X1.

The second claw 474 is provided to the second spacer portion 484. The second claw 474 includes a fourth spacer portion 474a that is to be disposed between the second output bus bar 440 in the second recess 428 of the second core 420, and the bottom surface 428s of the second recess 428. As illustrated in FIG. 11D, the fourth spacer portion 474a of the second claw 474 is supported by a second support 474b provided in the lower direction Z2 from the end of the hole 458h of the spacer body 458 (the end of the right direction X1), and is provided in a manner extending in the left direction X2.

In the winding component 400G according to the example embodiment, with the configuration described above, as illustrated in FIG. 11E, it is possible to prevent contact between the first output bus bar 430 and the first core 410, and contact between the second output bus bar 440 and the second core 420 (contact in the up-down direction Z), effectively.

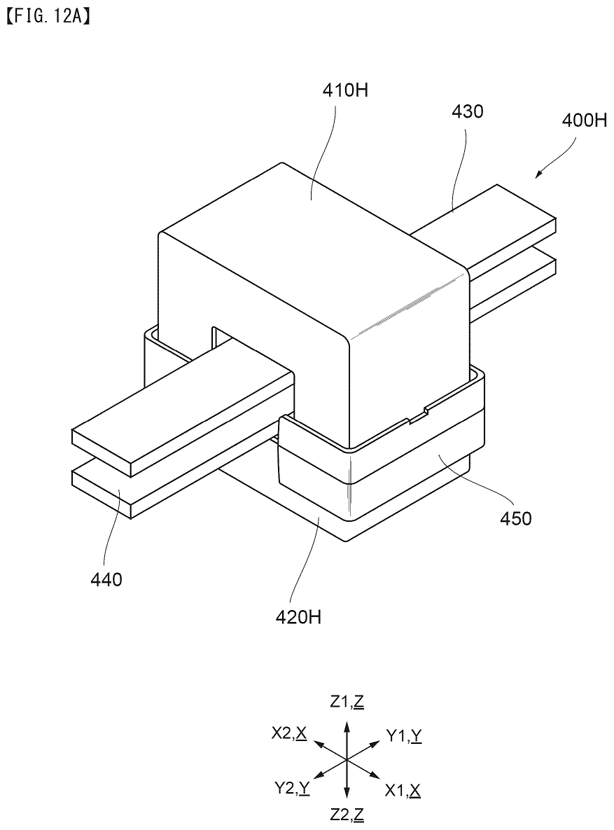

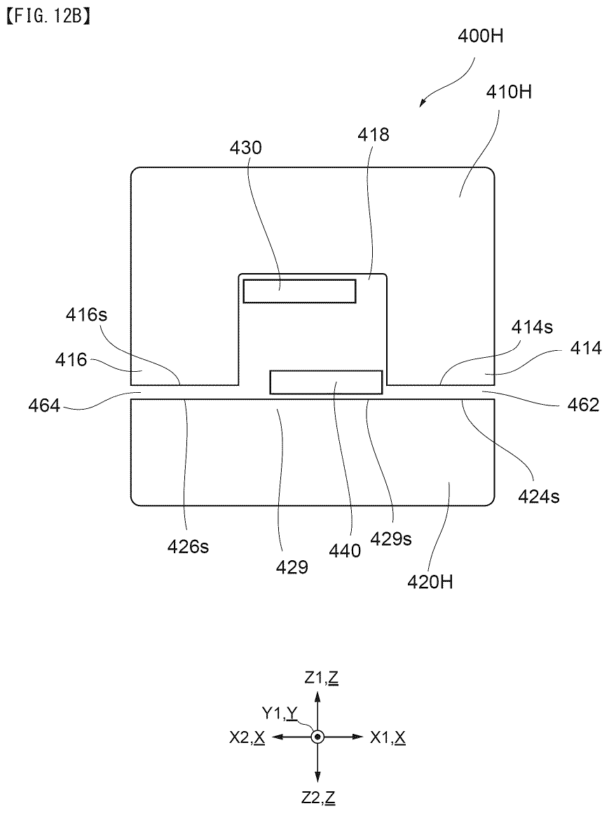

A winding component 400H including a first core 410H and a second core 420H according to another example of the example embodiment will be described with reference to FIGS. 12A and 12B. FIG. 12A is a perspective view of the winding component 400H including the first core 410H and the second core 420H as viewed from the upper direction Z1, and FIG. 12B is a cross-sectional view perpendicular to the front-back direction Y (the winding component 400H as viewed from a direction perpendicular to the ZX plane). In the example of the winding component 400 (e.g., FIGS. 3A and 3B) and the like having been described above, both of the first core 410 and the second core 420 are provided with recesses (the first recess 418 and the second recess 428), respectively, but the present technology is not limited thereto. In the example embodiment, one of the two cores (the first core 410H) may be provided with the recess (the first recess 418), and the other core may be provided with a flat portion (flat portion 429 to be described later), instead of the recess, as in the winding component 400H according to the example embodiment illustrated in FIGS. 12A and 12B.

In other words, in the winding component 400H according to the example embodiment, the first core 410H may include the first core facing surface 414s, the second core facing surface 416s, and the first recess 418 provided between the first core facing surface 414s and the second core facing surface 416s. The second core 420H may include the third core facing surface 424s, the fourth core facing surface 426s, and the flat portion 429 provided between the third core facing surface 424s and the fourth core facing surface 426s. The first core 410H and the second core 420H may be disposed in such a manner that the first core facing surface 414s and the third core facing surface 424s face each other across the first gap 462 in the first direction (up-down direction Z) that intersects with the direction of the first current (the direction from the rear direction Y2 toward the front direction Y1) and the direction of the second current (the direction from the front direction Y1 toward the rear direction Y2); that the second core facing surface 416s and the fourth core facing surface 426s face each other across the second gap 464, in the first direction (the up-down direction Z); and that the first recess 418 and the flat portions 429 face each other in the first direction (the up-down direction Z).

As illustrated in FIG. 12A, in the winding component 400H according to the example embodiment, for example, the spacer 450 may be disposed between the first core 410H and the second core 420H, and the spacer 450 may align the first core 410H and the second core 420H in such a manner that gaps are formed between the first core 410H and the second core 420H in the up-down direction Z (the first gap 462 and the second gap 464). Also, as illustrated in FIG. 12B, in the winding component 400H, it is also possible for the first output bus bar 430 to be disposed inside of the first recess 418, and for the second output bus bar 440 to be provided on the flat portion 429.

As illustrated in FIG. 12B, in the surface of the second core 420H of the winding component 400H in the upper direction Z1, for example, the third core facing surface 424s may serve as the portion that faces the first core facing surface 414s that is in the lower direction Z2 of the first core 410H; the fourth core facing surface 426s may serve as the portion facing the second core facing surface 416s that is in the lower direction Z2 of the first core 410H; and the flat portion 429 may serve as the portion between the third core facing surface 424s and the fourth core facing surface 426s (between the third core facing surface 424s and the fourth core facing surface 426s in the left-right direction X in FIG. 12B). Also, a surface 429s of the flat portion 429 in the upper direction Z1 may be on the same plane as the third core facing surface 424s and the fourth core facing surface 426s, as illustrated in FIG. 12B.

In the example described above with reference to FIGS. 12A and 12B, the first recess 418 is provided to the first core 410H that is to be disposed on the upper direction Z1, among the two cores, and the flat portion 429 is provided to the second core 420H to be disposed on the lower direction Z2, but the example embodiment is not limited thereto. For example, another possible configuration is a configuration in which: the first recess is not provided between the first core facing surface 414s and the second core facing surface 416s; a flat portion similar to the flat portion 429 is provided to the first core 410H; and the second core 420H is provided with the second recess 428 (see FIG. 7, for example) between the third core facing surface 424s and the fourth core facing surface 426s.

Similarly to the winding components 400A to 400D described with reference to FIGS. 8A to 8D, even in a configuration in which a flat portion (the flat portion 429) is provided to one of the first core 410H and the second core 420H (the second core 420H in the winding component 400H illustrated in FIGS. 12A and 12B), the arrangement, the sizes, and/or the cross-sectional areas, or the like of the first output bus bar 430 and the second output bus bar 440 may be adjusted.

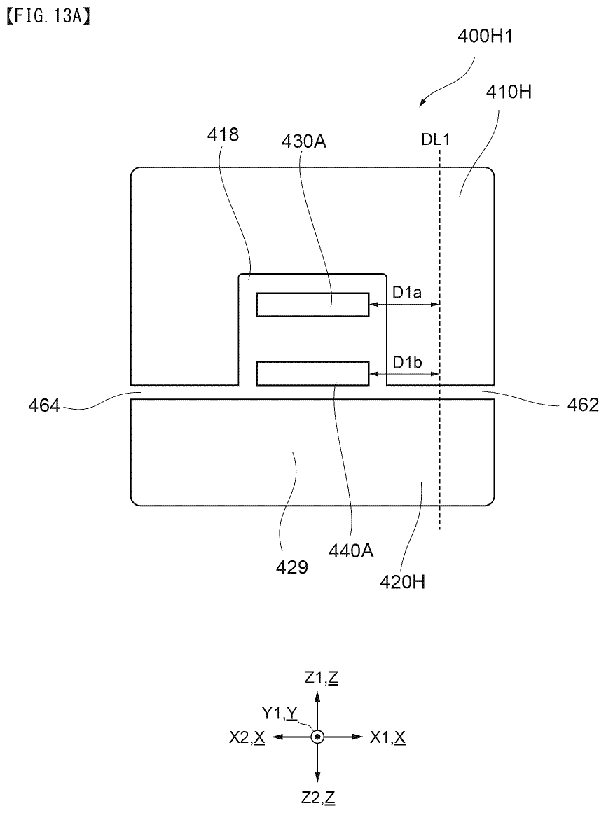

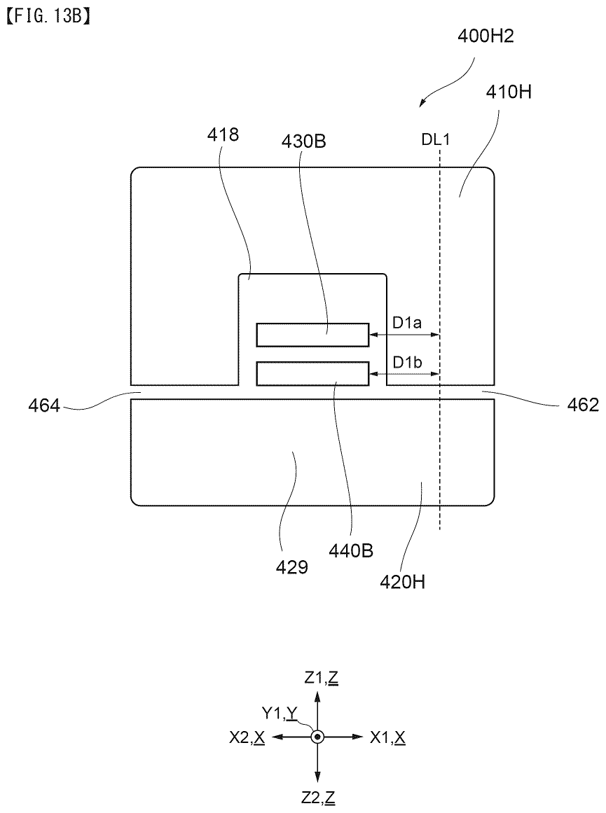

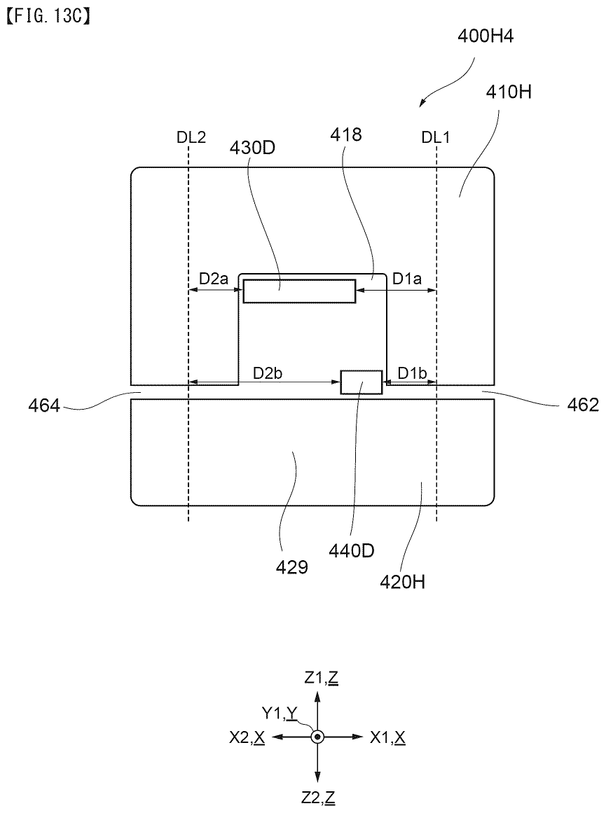

For example, as a winding component 400H1 illustrated in FIG. 13A, the first output bus bar 430A and the second output bus bar 440A may have the same shape in a cross-sectional view, and substantially the same cross-sectional areas, similarly to those in the winding component 400A (FIG. 8A). The first output bus bar 430A and the second output bus bar 440A may also be disposed at the same position in the left-right direction X (so that the distances thereof (the first distance D1a and the second distance D1b) with respect to the first gap 462 are substantially equal).

Also, for example, as a winding component 400H2 illustrated in FIG. 13B, the first output bus bar 430B and the second output bus bar 440B may have the same shape in a cross-sectional view, and have the substantially the same cross-sectional area; the first output bus bar 430B and the second output bus bar 440B may be disposed at the same position in the left-right direction X; and the first output bus bar 430B may be disposed further in the lower direction Z2 with respect to the second output bus bar 440B, and the second output bus bar 440B may be disposed further in the upper direction Z1 with respect to the first output bus bar 430B, similarly to the winding component 400B (FIG. 8B).

Also, for example, as a winding component 400H4 illustrated in FIG. 13C, the first output bus bar 430D and the second output bus bar 440D may have different shapes in the cross-sectional view; the first output bus bar 430D may have a cross-sectional area larger than that of the second output bus bar 440D; the distance D1a of the first output bus bar 430D and the distance D1b of the second output bus bar 440D with respect to the first gap 462 may be different from each other in the left-right direction X; and the distance D2a and the distance D2b with respect to the second gap 464 may be different from each other, similarly to the winding component 400D (FIG. 8D). Also, as illustrated in FIG. 13C, in the winding component 400H4, the first output bus bar 430D and the second output bus bar 440D may be disposed in such a manner that the distance D1a is larger than the distance D1b, and the first output bus bar 430D and the second output bus bar 440D may be disposed in such a manner that, in relation to the distance D2a and the distance D2b with respect to the second gap 464, the distance D2b between the second gap 464 and the second output bus bar 440D is larger than the distance D2a between the second gap 464 and the first output bus bar 430D.

As described above, also in a configuration in which a flat portion (the flat portion 429) is provided to one of the first core 410H and the second core 420H (e.g., the second core 420H) instead of the recess (the second recess 428), as in the case of the winding component 400H according to the example embodiment, the arrangement, the sizes, the cross-sectional areas, and/or shapes of the output bus bars (the first output bus bar 430 and the second output bus bar 440) may be adjusted. Thus, the self-inductances of and the coupling coefficient between the first output bus bar 430 and the second output bus bar 440 can be adjusted in the winding components 400H, 400H1, 400H2, and 400H4, in a manner similar to that described above with reference to FIGS. 9A and 9B.

The example embodiment described above is intended to facilitate the understanding of the present technology, and is not intended to limit the scope of the present technology in any way. Each of the elements included in the example embodiment, and the arrangement, materials, conditions, shapes, and sizes of the elements are not limited to those in the illustrated examples, and may be changed as appropriate. It is also possible to replace or combine some parts of the configurations described in the different example embodiments.

1. A winding component comprising:
a first core;
a second core disposed facing the first core;
a first output bus bar via which a first voltage is output;
a second output bus bar via which a second voltage is output, wherein
the first output bus bar and the second output bus bar are disposed between the first core and the second core, and
a direction of a first current passed through the first output bus bar is different from a direction of a second current passed through the second output bus bar.

2. The winding component according to claim 1, wherein
the first core has a first core facing surface, a second core facing surface, and a first recess provided between the first core facing surface and the second core facing surface,
the second core has a third core facing surface, a fourth core facing surface, and a second recess provided between the third core facing surface and the fourth core facing surface,
the first core and the second core are positioned in such a manner that:
the first core facing surface and the third core facing surface face each other across the first gap, in a first direction intersecting with the direction of the first current and the direction of the second current;
the second core facing surface and the fourth core facing surface face each other across a second gap in the first direction; and
the first recess and the second recess face each other in the first direction,
the first output bus bar is disposed inside of the first recess,
the second output bus bar is disposed inside of the second recess, and
a distance between the first gap and the first output bus bar is different from a distance between the first gap and the second output bus bar.

3. The winding component according to claim 2, wherein a distance between the second gap and the first output bus bar is different from a distance between the second gap and the second output bus bar.

4. The winding component according to claim 1, wherein a cross-sectional area of the first output bus bar, the cross-sectional area being orthogonal to the direction of the first current, is different from a cross-sectional area of the second output bus bar, the cross-sectional area being orthogonal to the direction of the second current.

5. The winding component according to claim 1, wherein at least one of the first output bus bar and the second output bus bar has a bent portion.

6. The winding component according to claim 5, wherein
the first core has a first core facing surface, a second core facing surface, and a first recess provided between the first core facing surface and the second core facing surface,
the second core has a third core facing surface, a fourth core facing surface, and a second recess provided between the third core facing surface and the fourth core facing surface,
the first core and the second core are positioned in such a manner that:
the first core facing surface and the third core facing surface face each other across the first gap, in a first direction intersecting with the direction of the first current and the direction of the second current;
the second core facing surface and the fourth core facing surface face each other across a second gap in the first direction; and
the first recess and the second recess face each other in the first direction,
the first output bus bar is disposed inside of the first recess,
the second output bus bar is disposed inside of the second recess,
a distance between the first gap and the first output bus bar is substantially equal to a distance between the first gap and the second output bus bar, and
a distance between the second gap and the first output bus bar is different from a distance between the second gap and the second output bus bar.

7. The winding component according to claim 1, wherein
the first core has a first core facing surface, a second core facing surface, and a first recess provided between the first core facing surface and the second core facing surface,
the second core has a third core facing surface, a fourth core facing surface, and a flat portion provided between the third core facing surface and the fourth core facing surface, and
the first core and the second core are positioned in such a manner that:
the first core facing surface and the third core facing surface face each other across the first gap, in a first direction intersecting with the direction of the first current and the direction of the second current;
the second core facing surface and the fourth core facing surface face each other across a second gap in the first direction; and
the first recess and the flat portion face each other in the first direction.

8. A power supply device comprising:
a voltage input unit;
a voltage conversion unit;
a voltage output unit; and
the winding component according to any one of claims 1 to 7.
